(19) United States
(12) Patent Application Publication
(10) Pub. No.: US 2002/0122571 A1
(43) Pub. Date: Sep. 5, 2002

(54) Identity verification using biometrics in analog format

(76) Inventors: Shawn Bradley, Missoula, MT (US); Richard Peralta, Stevensville, MT (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/797,751

(22) Filed: Mar. 1, 2001

(51) Int. Cl. G06K 9/00; G06T 1/00; H04Q 1/00; H04B 1/00; H04B 3/00; G06K 9/20; H04Q 9/00; G06F 7/00; G06T 7/00; G06F 7/04

(52) U.S. Cl. 382/115; 340/5.53; 340/5.83

(57) ABSTRACT

A system for identity-based authorization of a user to access an account is disclosed. In a preferred embodiment of the invention, the system employs a token comprising a token body. A medium carrying at least one characteristic descriptive of the account is carried by the token body. A transmissive member carrying a biometric in analog format occupies a cutaway region of the token body. The system further employs a token receiver adapted to receive the token. A light source is disposed on a first side of the receiver. An image capturing apparatus is positioned to receive light emitted by the light source. A first processor is in communication with the image capturing apparatus. A biometric sampler is in communication with the first processor. In operation, the system comprises creating at least one first indicator describing at least one portion of the analog biometric associated with the token. At least one second indicator describing at least one portion of a bid biometric of the user is further created. At least one third indicator describing at least one portion of a registration biometric of the user is further created. The first and second indicators are compared. By comparing the first and second indicators, either a successful or failed first identification of the user is yielded. Upon successful first identification of the user, the first and third indicators are compared. By comparing the first and third indicators, either a successful or failed second identification of the user is yielded. Upon successful second identification of the user, access by the user to the account is authorized.

### BACKGROUND OF THE INVENTION

The present invention relates generally to identity verification systems and more particularly to a system for identity-based authorization of a user to access an account.

The use of a token, an inanimate object which confers a capability to the user presenting it, is pervasive in today's financial world. At the heart of every transaction is a money transfer enabled by a token, such as a plastic debit or credit swipe card, which acts to identify both the user as well as the financial account being accessed.

From their inception in the late 1970s, token-based systems for accessing financial services have grown increasingly more prevalent in the banking industry. However, as token-based systems access have become more popular with users, they have also become more popular with criminals intent on perpetrating fraud. Currently, fraud losses in the financial industry stem from many different areas, but they are mainly due to either stolen or counterfeit cards.

Generally, debit cards are used in conjunction with a personal identification number (PIN). The PIN helps to prevent lost or stolen cards from being used by criminals, but over time various strategies have been used to obtain PINs from unwary cardholders. Such strategies include Trojan horse automated teller machines (ATMs) in shopping malls that dispense cash but record the PIN, to fraudulent debit devices that also record the PIN, to criminals with binoculars that watch cardholders enter PINs at ATMs. The subsequently manufactured counterfeit debit cards are then used in various ATM machines to fraudulently withdraw funds until the account is emptied.

User-based fraud for debit cards is also on the rise. Users intent on this sort of fraud will claim that they lost their card, say that their PIN was written on the card, and then withdraw money from their account using card, and then refuse to be responsible for the loss.

The financial industry is constantly taking steps to improve the security of tokens, such as debit cards and new smartcards. However, the linkage between the user and his token remains tenuous, and that is the fundamental reason behind the increasing card fraud.

One solution that would reduce counterfeit-card fraud involves using a smartcard that includes a biometric. In this approach, authenticated biometrics are recorded from a user of known identity and stored for future reference on a token. In every subsequent account access, the user is required to physically enter the requested biometric, which is then compared to the authenticated biometric on the token to determine if the two match in order to verify user identity.

Various biometrics have been suggested for use with smartcards, such as fingerprints, hand prints, voice prints, retinal images, handwriting samples and the like. However, the biometrics are generally stored on a token in electronic form, and thus the biometrics can be fraudulently copied and reproduced. Because the comparison and verification process is not isolated from the hardware and software directly used by the user attempting access, a significant risk of fraud still exists.

An example of another token-based biometric smartcard system can be found in U.S. Pat. No. 5,280,527 to Gullman et al. In Gullman's system, the user must carry and present a credit card sized token (referred to as a biometric security apparatus) containing a microchip in which is recorded characteristics of the authorized user's voice. In order to initiate the access procedure, the user must insert the token into a ATM such as an ATM, and then speak into the ATM to provide a biometric sample for comparison with an authenticated sample stored in the microchip of the presented token. If a match is found, the remote ATM signals the host computer that the account access should be permitted, or may prompt the user for an additional code, such as a PIN which is also stored on the token, before authorizing the account access.

Although Gullman's reliance on comparing biometrics reduces the risk of unauthorized access as compared to PIN codes, Gullman's failure to isolate the identity verification process from the possibility of tampering greatly diminishes any improvement to fraud resistance resulting from the replacement of a PIN with a biometric.

There is thus a need for a financial account access system that identifies the user, as opposed to merely verifying a user's possession of any physical objects that can be freely transferred or altered. This will result in a dramatic decrease in fraud, as only the authentic user can access his or her account.

### SUMMARY OF THE INVENTION

In accordance with the present invention, a system for identity-based authorization of a user to access an account is disclosed. For purposes of the present invention, the term “account” is to be broadly construed to include a right or rights accessible based on positive user identification, such as, but not limited to, financial accounts, driving privileges, foreign travel privileges, access to restricted areas and the like.

In a preferred embodiment of the invention, the system employs a token comprising a token body. A medium carrying at least one characteristic descriptive of the account is carried by the token body. A transmissive member carrying a biometric in analog format occupies a cutaway region of the token body.

The system further employs a token receiver adapted to receive the token. A light source is disposed on a first side of the receiver. An image capturing apparatus is positioned to receive light emitted by the light source. A first processor is in communication with the image capturing apparatus. A biometric sampler is in communication with the first processor.

In operation, the system comprises creating at least one first indicator describing at least one portion of the analog biometric associated with the token. At least one second indicator describing at least one portion of a bid biometric of the user is further created. At least one third indicator describing at least one portion of a registration biometric of the user is further created. The first and second indicators are compared. By comparing the first and second indicators, either a successful or failed first identification of the user is yielded. Upon successful first identification of the user, the first and third indicators are compared. By comparing the first and third indicators, either a successful or failed second identification of the user is yielded. Upon successful second identification of the user, access by the user to the account is authorized.

### BRIEF DESCRIPTION OF THE DRAWINGS

FIG. 1 is a front plan view of a token used in accordance with principles of the present invention;

FIG. 2A is an upper perspective view of an authorization terminal according to principles of the present invention;

FIG. 2B is a partial upper perspective cross-sectional view of the authorization terminal of FIG. 2A;

FIG. 3 is a flowchart depicting preliminary identification of a user attempting to access an account using a token according to principles of the present invention;

FIG. 4 is a flowchart depicting verified identification of a user attempting to access an account using a token according to principles of the present invention; and

FIG. 5 is a flowchart depicting preliminary identification of a user attempting to access an account using a token according to an alternative embodiment of the present invention.

### DESCRIPTION OF THE SPECIFIC EMBODIMENTS

The drawing figures are intended to illustrate the general manner of construction and are not to scale. In the description and in the claims, the terms left, right, front and back and the like are used for descriptive purposes. However, it is understood that the embodiment of the invention described herein is capable of operation in other orientations than are shown and the terms so used are only for the purpose of describing relative positions and are interchangeable under appropriate circumstances.

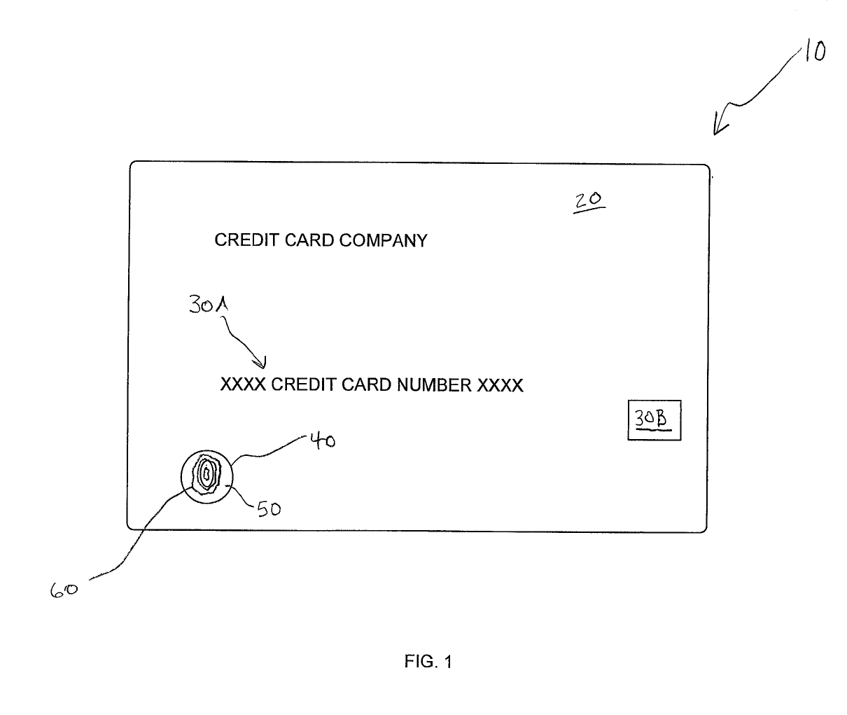

FIG. 1 illustrates in front plan view a token 10 incorporating features in accordance with a preferred embodiment of the present invention. Token 10 comprises a body 20 composed of plastic, metal or any other material suitable for construction of an account access token known in the art. Body 20 carries at least one account information medium 30. Information medium 30 carries at least one characteristic descriptive of an account to which a user of token 10 wishes to gain access. Such an account characteristic may comprise credit or debit account numbers, a digitally-formatted biometric, PIN authentication information or other information known in the art to be suitable for identifying accounts. Information medium 30 may comprise a series of raised symbols 30A, a smart-chip 30B, a magnetic strip (not shown) or any other suitable readable medium known to be adaptable to carry account-identifying information.

Token 10 further comprises a cutaway region 40 punched or otherwise formed from and through body 20. A transmissive member 50 occupies cutaway region 40. For purposes of the present discussion, the term “transmissive” shall be synonymous with the term “non-opaque.” Transmissive member 50 is preferably cellulose-based, but may comprise any suitable transmissive film material known in the art. Alternatively, transmissive member 50 is carried by body 20 at a corner or edge of body 20. A biometric layer 60 is disposed on a surface or between surfaces of transmissive member 50. Biometric layer 60 is composed of a material that is opaque or of lower transmissivity than that of transmissive member 50 and defines a biometric. The biometric defined by layer 60 is preferably a fingerprint, although the biometric could comprise any biometric susceptible to analog formatting, including but not limited to hand prints, retinal images, and handwriting samples. As such, an image of the biometric defined by biometric layer 60 may be projected upon a surface by directing light through transmissive member 50.

In the preferred embodiment of the present invention, token 10 is created by an issuing entity, such as a bank or credit card company or a driver license or passport issuing authority, upon receipt of an application to establish an account to be token accessed by a user. As part of this application process, the user will submit a biometric, preferably a fingerprint, to the issuing entity. The issuing entity, in turn, replicates the submitted biometric to form biometric layer 60 and digitizes the submitted biometric for storage and later comparison with a digitized image of biometric layer 60, as discussed in further detail below.

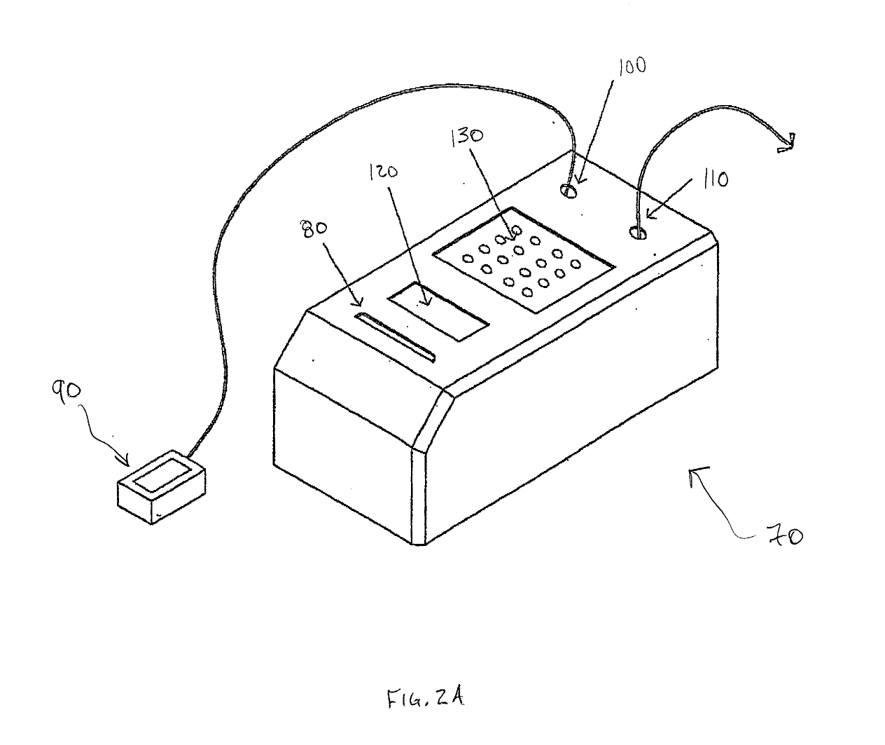

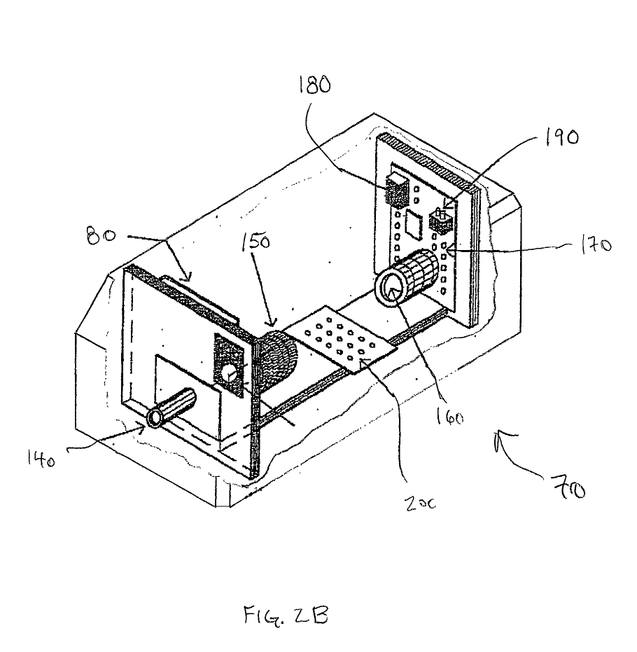

FIG. 2A is an upper perspective view of an authorization terminal 70 according to principles of the present invention. Terminal 70 is adaptable to be mounted on any supporting surface involved in a point of sale or financial transaction. Terminal 70 comprises a slot 80 adapted to receive token 10. Slot 80 preferably comprises a magnetic read head and/or other devices adapted to read information from information medium 30. Terminal 70 further comprises a biometric sampler such as a biometric scanner 90 that communicates with other components of terminal 70 through a biometric scanner port 100. Preferably, scanner 90 is a fingerprint scanner known in the art. Terminal 70 receives power through a power port 110. Terminal 70 optionally further comprises a LED display 120 and a keypad 130.

FIG. 2B is a partial upper perspective cross-sectional view of the authorization terminal 70. As can be seen therein, terminal 70 further comprises a light source 140 disposed at one end of terminal 70 and adapted to project light through a transmissive region (not shown) of slot 80 and a lens apparatus 150 to an image capturing apparatus 160. Mirrors or prisms (not shown) may optionally be included for directing light from light source 140 to apparatus 160, thereby enabling variable sizing of terminal 70. Light source 140 preferably comprises a green LED but may comprise any suitable light-emitting device known in the art. Preferably, a switch (not shown) is disposed proximate to slot 80 in such manner as to activate light source 140 in response to insertion of token 10 into slot 80. Apparatus 160 preferably comprises a digital camera but may comprise any suitable electronic video device known in the art. Terminal 70 further comprises a first computer board 170 communicating with and, illustratively, upon which is disposed image capturing apparatus 160, biometric scanner port block 180 and power port block 190. Port block 180 communicates with scanner 90. Port block 190 receives an external power on behalf of terminal 70. Terminal 70 further comprises a CPU 200 that communicates with first computer board 170 via a bus (not shown) or other suitable connecting device. Alternatively, CPU 200 may be disposed externally to but in communication with the components of terminal 70.

CPU 200 may be configured to perform a plurality of functions according to the teachings of the present invention. These functions are typically performed by software code modules stored in a memory and executing on CPU 200. The functions may also be performed by hardware modules coupled to CPU 200, or by a combination of software and hardware modules. Each step of the inventive processes discussed below not requiring manual activity may be performed by CPU 200 in response to such code modules.

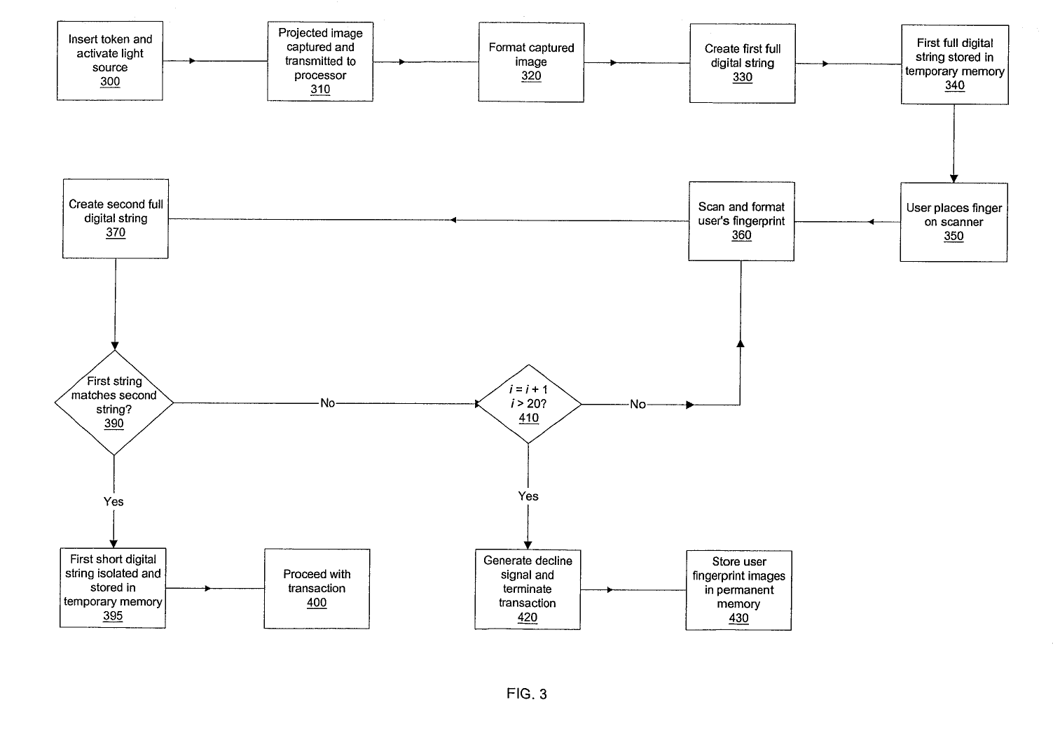

FIG. 3 is a flowchart depicting preliminary identification of a user attempting to access an account using token 10. At initial step 300, token 10 is inserted into slot 80 of terminal 70. Insertion of token 10 into slot 80 triggers a switch that activates light source 140. Insertion of token 10 into slot 80 enables alignment of transmissive member 50 with light source 140. Light emitted by source 140 passes through transmissive member 50 and projects an image of biometric layer 60 through lens 150 to camera 160. At step 310, camera 160 captures the projected image and transmits the projected image to processor 200. If, for whatever reason, an incomplete or insufficient projected image is so transmitted, an error signal is generated to display 120. At step 320, processor 200 formats the image by centering, deskewing, sizing, and cropping the image to it desired size (preferably, 400 pixels by 400 pixels). In this formatting step, the projected image is preferably formatted into a bitmap image, although a JPEG, TIFF or other appropriate image formatting scheme may be employed. At step 330, processor 200 digitizes the formatted fingerprint image, thereby creating an indicator in the form of a first full digital string describing the entire fingerprint image.

At step 340, the first full digital string is stored in temporary memory. At step 350, the person (“user”) attempting to use token 10 for access to a corresponding account places the finger from which a fingerprint was taken in the application process described above on scanner 90. At step 360, the finger is scanned to create a bid fingerprint image and processor 200 formats this image to its desired size as similarly described above. At step 370, processor 200 digitizes the formatted scanned fingerprint image, thereby creating a second full digital string describing the entire scanned fingerprint image. At step 390, processor 200 compares the first and second digital strings.

If a predetermined and variable percentage of the second digital string matches the first digital string, then, at step 395, processor 200 isolates a predetermined portion of the first full digital string and stores this isolated indicator in the form of a first “short” digital string in temporary memory. By creating and manipulating short strings, the system of the present invention undermines attempts to reproduce the biometric for fraudulent purposes. For purposes of further security, this short string, and each of the short strings described herein, may be encrypted in a manner known in the art. In the preferred embodiment, this short string, and each of the short strings described herein, is a variable predetermined number of contiguous digits within the full digital string. However, each short string may alternatively comprise digits selected from a variable predetermined set of positions, either contiguous or non-contiguous, within the full digital string.

At step 400, the attempted transaction is allowed to proceed. If no such match is verified, then, at step 410, a counter i is incremented and the process conditionally returns to step 360. Preferably, the process is so repeated up to 20 times or until match verification occurs. Each scanned image of the user's fingerprint is saved in temporary memory. If, after 20 repeats of step 360 (i>20), there is no match verification, then, at step 420, a decline signal is generated to display 120 and the transaction attempt is terminated. If the process is so terminated, then, at step 430, the scanned images of the user's fingerprint saved in temporary memory are saved in a permanent memory location and can be transmitted to law enforcement agencies if appropriate.

In the preferred embodiment of the present invention, as discussed above, a second processor controlled by the entity that issued token 10 digitizes the fingerprint of the person to whom token 10 has been issued during the process of application for token 10. Digitization of this fingerprint yields a third full digital string describing the entire fingerprint submitted in the application process. The issuing entity isolates a predetermined portion of the third full digital string to create a third “short” digital string. The third short string is taken from a region of the third full string corresponding to the region of the first full string from which the first short string was taken. Like correspondence should be assumed throughout the discussion herein of short string creation. The third short digital string is stored in memory, preferably at a site under the control of the issuing entity. As is the case with the above-discussed first full digital string, the third full digital string is preferably as many as 1248 digits in length. As is the case with the above-discussed first short digital string, the third short digital string is preferably as few as 8 digits in length.

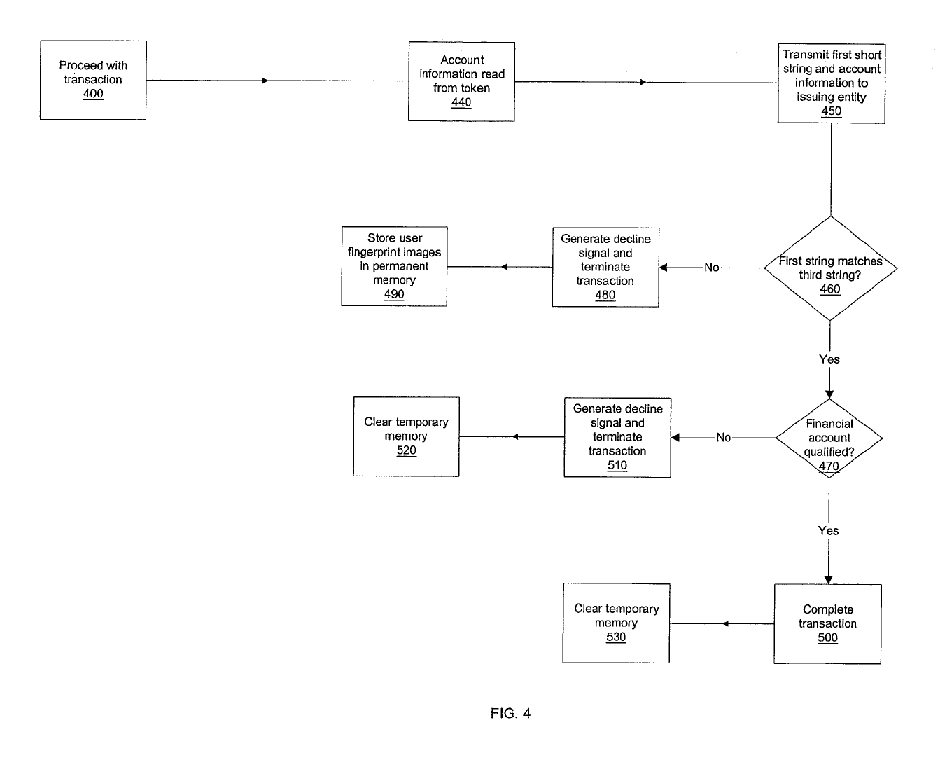

As shown in FIG. 4, upon reaching step 400, the process proceeds to step 440 whereupon the user removes token 10 from slot 80, and information pertaining to the account associated with token 10 is read from information medium/media 30. Alternatively, the user removes token 10 from slot 80 and swipes token 10 through an optional device adapted to read information medium/media 30, in communication with terminal 70, and known in the art. The user may be prompted to remove token 10 from slot 80 by a generated message on display 120, an audible signal generated by a speaker incorporated by terminal 70, or other appropriate devices known in the art. At step 450, the first short digital string is bundled with the account information read at step 440, and this bundled data is transmitted by CPU 200 to the above-discussed second processor associated with the issuing entity. At step 460, the second processor retrieves the third short digital string from a database controlled by the issuing entity and compares the first and third short strings.

If a predetermined and variable percentage of the first short digital string matches the third short digital string, the process proceeds to step 470. If no such match is verified, then, at step 480, a decline signal is generated to display 120 and the transaction attempt is terminated. Alternatively, repeated subsequent derivations of a first short string from the token and comparisons of these first short strings with the third short string may be performed a predetermined number of times. If the process is so terminated, then, at step 490, the scanned images of the user's fingerprint saved in temporary memory are saved in a permanent memory location and can be transmitted to law enforcement agencies if appropriate. Terminal 70 is then reset for the next transaction. Alternatively, the second short digital string, rather than the first short string, could be likewise transmitted to the second processor and compared with the third short digital string in order to facilitate the above-described process.

At step 470, the second processor evaluates the bundled account information. If the account to which access is desired meets qualifying requirements (e.g., account is not overdrawn, credit limit not exceeded, user is authorized entry, etc.), the process proceeds to step 500. If the account requirements are not so met, then, at step 510, a decline signal is generated to display 120 and the transaction attempt is terminated. If the process is so terminated, then, at step 520, the temporary memory containing the samples of the live fingerprint scan and the read account information is cleared or reset. Terminal 70 is then reset for the next transaction.

At step 500, the desired transaction occurs and a verified code or other information indicating acceptance of the transaction is generated to display 120. At step 530, the temporary memory containing the samples of the live fingerprint scan and the read account information is cleared or reset. Terminal 70 is then reset for the next transaction.

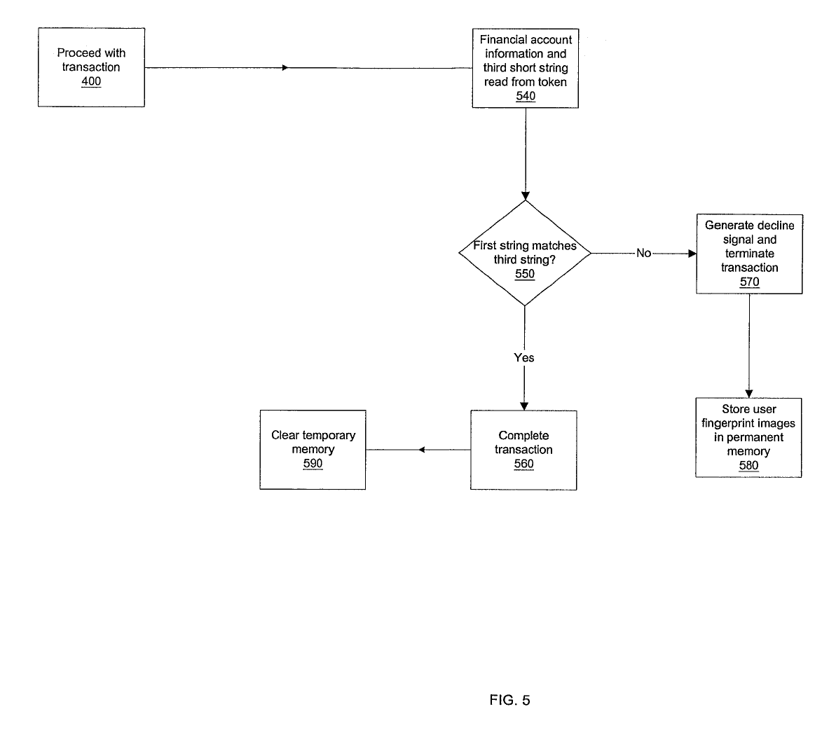

In an alternative embodiment of the present invention, the third short digital string is stored on information medium/media 30. Terminal 70 is equipped in conventional manner to read data from information medium/media 30. Accordingly, when token 10 is inserted into slot 80, terminal 70 reads the third short string from information medium/media 30. In this embodiment, and as shown in FIG. 5, upon reaching step 400, the process proceeds to step 540 whereupon the user removes token 10 from slot 80, and information pertaining to the account associated with token 10 and the third short string are read from information medium/media 30. Alternatively, the user removes token 10 from slot 80 and swipes token 10 through an optional device adapted to read information medium/media 30, in communication with terminal 70, and known in the art. The user may be prompted to remove token 10 from slot 80 by a generated message on display 120, an audible signal generated by a speaker incorporated by terminal 70, or other appropriate devices known in the art. At step 550, processor 200 compares the first and third short strings.

If a predetermined and variable percentage of the first short digital string matches the third short digital string, the process proceeds to step 560. If no such match is verified, then, at step 570, a decline signal is generated to display 120 and the transaction attempt is terminated. If the process is so terminated, then, at step 580, the scanned images of the user's fingerprint saved in temporary memory are saved in a permanent memory location and can be transmitted to law enforcement agencies if appropriate. Terminal 70 is then reset for the next transaction. Alternatively, the second short digital string, rather than the first short string, could be likewise compared with the third short digital string in order to facilitate the above-described process.

At step 560, the desired transaction occurs and a verified code indicating acceptance of the transaction is generated to display 120. At step 590, the temporary memory containing the samples of the live fingerprint scan and the read account information is cleared or reset. Terminal 70 is then reset for the next transaction.

In yet another alternative embodiment of the present invention, at step 400, the custodian of terminal 70 is satisfied that token 10 has not been forged and the user is the person to whom token 10 has been legitimately issued. Consequently, information pertaining to the account associated with token 10 is read from information medium/media 30 and the transaction is completed. The temporary memory containing the samples of the live fingerprint scan and the read account information is cleared or reset. Terminal 70 is then reset for the next transaction.

Although the invention has been described in terms of the illustrative embodiment, it will be appreciated by those skilled in the art that various changes and modifications may be made to the illustrative embodiment without departing from the spirit or scope of the invention. For example, terminal 70 may incorporate or be used in conjunction with a point-of-sale token reader known in the art. In addition, the above-described system may similarly authorize access to an account by comparing full digital strings rather than short digital strings throughout the entirety of the above-described processes. In addition, during preliminary user identification, as illustrated in FIG. 3, short, rather than full, digital strings may be derived from both the first and second full strings and employed for comparison. In addition, token 10 may comprise a passport, driver license, or door/zone access card. It is intended that the scope of the invention not be limited in any way to the illustrative embodiment shown and described but that the invention be limited only by the claims appended hereto.

What is claimed is:

1. In a token-based account access arrangement employing a reader adapted to read from a token information pertaining to the account, the token having disposed thereupon a projectable biometric, a system for identity-based authorization of a user to use the token for access to the account, the system comprising:
a token receiver;
a light source disposed on a first side of said receiver;
an image capturing apparatus positioned to receive light emitted by said light source;
a first processor in communication with said image capturing apparatus; and
a biometric sampler in communication with said first processor.

2. The system of claim 1, wherein said image capturing apparatus is disposed on a second side of said receiver opposite said first side.

3. The system of claim 1, wherein said receiver comprises a transmissive region, a portion of said transmissive region coinciding with the projectable biometric upon receipt of the token by said receiver.

4. The system of claim 1, further comprising:
a switch activatible in response to receipt by said token receiver of the token, said switch adapted to enable said light source when activated.

5. The system of claim 1, wherein said light source is adapted to project an image of the biometric upon said image capturing apparatus.

6. The system of claim 1, wherein said first processor is adapted to compare at least one depiction of the biometric disposed upon the token with at least one depiction of a biometric sample of the user captured by said sampler.

7. The system of claim 1, further comprising:
a second processor remote from said token receiver, said second processor in communication with said first processor.

8. The system of claim 7, further comprising a database in communication with said second processor, said database adapted to store a registration biometric, said second processor adapted to compare at least one depiction of said registration biometric with at least one depiction of a biometric sample of the user captured by said sampler.

9. The system of claim 1, further comprising:
a lens disposed between said token receiver and said image capturing apparatus.

10. A system for identity-based authorization of a user to access an account, the system comprising:
a token having disposed thereupon a projectable biometric;
a token receiver adapted to receive said token;
a light source disposed on a first side of said receiver;
an image capturing apparatus positioned to receive light emitted by said light source;
a first processor in communication with said image capturing apparatus; and
a biometric sampler in communication with said first processor.

11. The system of claim 10, wherein said image capturing apparatus is disposed on a second side of said receiver opposite said first side.

12. The system of claim 10, wherein said receiver comprises a transmissive region, a portion of said transmissive region coinciding with said projectable biometric upon receipt of said token by said receiver.

13. The system of claim 10, further comprising:
a switch activatible in response to receipt by said token receiver of said token, said switch adapted to enable said light source when activated.

14. The system of claim 10, wherein said light source is adapted to project an image of said biometric upon said image capturing apparatus.

15. The system of claim 10, wherein said first processor is adapted to compare at least one depiction of said biometric disposed upon said token with at least one depiction of a biometric sample of the user captured by said sampler.

16. The system of claim 10, further comprising:
a second processor remote from said token receiver, said second processor in communication with said first processor.

17. The system of claim 16, further comprising a database in communication with said second processor, said database adapted to store a registration biometric, said second processor adapted to compare at least one depiction of said registration biometric with at least one depiction of a biometric sample of the user captured by said sampler.

18. The system of claim 10, further comprising:
a lens disposed between said token receiver and said image capturing apparatus.

19. A system enabling token-based access by a user of a token to an account, the system comprising:
a token receiver;
a light source disposed on a first side of said receiver;
an image capturing apparatus positioned to receive light emitted by said light source;
a first processor in communication with said image capturing apparatus;
a biometric sampler in communication with said first processor; and
a token reader.

20. The system of claim 19, wherein said image capturing apparatus is disposed on a second side of said receiver opposite said first side.

21. The system of claim 19, wherein said token reader is adapted to read from a token information pertaining to the account.

22. The system of claim 19, wherein said receiver comprises a transmissive region, the token has disposed thereupon a projectable biometric, a portion of said transmissive region coinciding with said projectable biometric upon receipt of the token by said receiver.

23. The system of claim 19, further comprising:
a switch activatible in response to receipt by said token receiver of the token, said switch adapted to enable said light source when activated.

24. The system of claim 19, wherein said light source is adapted to project an image of a projectable biometric upon said image capturing apparatus.

25. The system of claim 19, wherein said first processor is adapted to compare at least one depiction of a biometric disposed upon the token with at least one depiction of a biometric sample of the user captured by said sampler.

26. The system of claim 19, further comprising:
a second processor remote from said token receiver, said second processor in communication with said first processor.

27. The system of claim 26, further comprising a database in communication with said second processor, said database adapted to store a registration biometric, said second processor adapted to compare at least one depiction of said registration biometric with at least one depiction of a biometric disposed upon the token.

28. The system of claim 19, further comprising:
a lens disposed between said token receiver and said image capturing apparatus.

29. A method for token-based access by a user of the token to at least one account, the method comprising:
creating at least one first indicator (digital string) describing at least one portion of an analog biometric associated with (formed on) the token;
creating at least one second indicator (digital string) describing at least one portion of a bid biometric of the user;
comparing said first and second indicators, said comparing of said first and second indicators yielding either a successful or failed first identification of the user; and
upon successful first identification of the user, authorizing access by the user to the at least one account.

30. The method of claim 29, wherein said authorizing further comprises:
creating at least one third indicator (digital string) describing at least one portion of a registration biometric of the user;
comparing said first and third indicators, said comparing of said first and third indicators yielding either a successful or failed second identification of the user; and
upon successful second identification of the user, authorizing access by the user to the at least one account.

31. The method of claim 30, wherein said at least one third indicator is readable from the token.

32. The method of claim 30, wherein said at least one third indicator is readable from memory at a location remote from the site where said creating at least one first indicator step is performed.

33. The method of claim 29, wherein said authorizing further comprises:
creating at least one third indicator (digital string) describing at least one portion of a registration biometric of the user;
comparing said first and third indicators, said comparing of said first and third indicators yielding either a successful or failed second identification of the user; and
upon successful second identification of the user, authorizing access by the user to the at least one account.

34. The method of claim 33, wherein said at least one third indicator is readable from the token.

35. The method of claim 33, wherein said at least one third indicator is readable from memory at a location remote from the site where said creating at least one first indicator step is performed.

36. The method of claim 29, wherein said creating at least one first indicator further comprises digitizing at least a first portion of said analog biometric, said digitizing producing a first digital string describing said first portion, said at least one first indicator describing a second portion of said analog biometric, said first portion comprising said second portion, said second portion being smaller than said first portion.

37. The method of claim 29, wherein said creating at least one second indicator further comprises scanning at least one finger of the user, said scanning producing said bid biometric.

38. The method of claim 29, wherein said creating at least one second indicator further comprises digitizing at least a first portion of said bid biometric, said digitizing producing a first digital string describing said first portion, said at least one second indicator describing a second portion of said bid biometric, said first portion comprising said second portion, said second portion being smaller than said first portion.

39. The method of claim 30, wherein said creating at least one third indicator further comprises digitizing at least a first portion of said registration biometric, said digitizing producing a first digital string describing said first portion, said at least one third indicator describing a second portion of said registration biometric, said first portion comprising said second portion, said second portion being smaller than said first portion.

40. The method of claim 29, wherein said analog biometric comprises an image of at least one fingerprint of the user.

41. The method of claim 40, wherein said image is disposed on microfilm.

42. The method of claim 29, wherein said successful first identification of the user is yielded if a predetermined percentage of said at least one second indicator matches said at least one first indicator.

43. The method of claim 30, wherein said successful second identification of the user is yielded if a predetermined percentage of said at least one first indicator matches said at least one third indicator.

44. The method of claim 29, further comprising:
upon failed first identification of the user, creating at least one subsequent second indicator describing at least one portion of a bid biometric of the user;
comparing said first and subsequent second indicators, said comparing of said first and subsequent second indicators yielding either a subsequent successful or subsequent failed first identification of the user; and
upon subsequent successful first identification of the user, authorizing access by the user to the at least one account.

45. The method of claim 30, further comprising:
upon failed second identification of the user, creating at least one subsequent first indicator;
comparing said third and subsequent first indicators, said comparing of said third and subsequent first indicators yielding either a subsequent successful or subsequent failed second identification of the user; and
upon subsequent successful second identification of the user, authorizing access by the user to the at least one account.

46. The method of claim 29, further comprising storing said at least one first indicator in first (temporary) memory.

47. The method of claim 46, further comprising:
upon said successful first identification of the user, clearing said at least one first indicator from said first memory.

48. The method of claim 29, further comprising storing said at least one bid biometric portion in first memory.

49. The method of claim 48, further comprising:
upon said successful first identification of the user, clearing said at least one bid biometric portion from said first memory.

50. The method of claim 48, further comprising:
upon said failed first identification of the user, storing said at least one bid biometric portion in a second (permanent) memory.

51. The method of claim 30, further comprising storing said at least one first indicator in first memory.

52. The method of claim 51, further comprising:
upon said successful second identification of the user, clearing said at least one first indicator from said first memory.

53. The method of claim 30, further comprising storing said at least one bid biometric portion in first memory.

54. The method of claim 53, further comprising:
upon said successful second identification of the user, clearing said at least one bid biometric portion from said first memory.

55. The method of claim 53, further comprising:
upon said failed second identification of the user, storing said at least one bid biometric portion in a second memory.

56. A system for identity-based authorization of a user to access an account, the system comprising:
means for carrying a projectable biometric;
means for receiving said biometric carrying means;
means for projecting an image of said projectable biometric, said means for projecting disposed on a first side of said receiving means;
means for capturing said projected image, said means for capturing positioned to receive light emitted by said projecting means;
a first processor in communication with said capturing means; and
means for sampling a biometric of the user, said sampling means in communication with said first processor.

57. The system of claim 56, wherein said capturing means is disposed on a second side of said receiving means opposite said first side.

58. The system of claim 56, wherein said receiving means comprises a transmissive region, a portion of said transmissive region coinciding with said projectable biometric upon receipt of said carrying means by said receiving means.

59. The system of claim 56, further comprising:
switch means for enabling said projection means when activated, said switch means activatible in response to receipt by said receiving means of said carrying means.

60. The system of claim 56, wherein said projection means is adapted to project an image of said biometric upon said capturing means.

61. The system of claim 56, wherein said first processor is adapted to compare at least one depiction of said biometric carried by said carrying means with at least one depiction of a biometric sample of the user captured by said sampling means.

62. The system of claim 56, further comprising:
a second processor remote from said receiving means, said second processor in communication with said first processor.

63. The system of claim 62, further comprising means for storing a registration biometric, said storage means in communication with said second processor, said second processor adapted to compare at least one depiction of said registration biometric with at least one depiction of a biometric sample of the user captured by said sampling means.

64. The system of claim 56, further comprising means for image forming disposed between said receiving means and said capturing means.

65. A method for token-based access by a user of the token to at least one account, the method comprising:
creating at least one first indicator for describing at least one portion of an analog biometric associated with the token;
creating at least one second indicator for describing at least one portion of a bid biometric of the user;
comparing said first and second indicators for yielding either a successful or failed first identification of the user; and
upon successful first identification of the user, authorizing access by the user to the at least one account.

66. The method of claim 65, wherein said authorizing further comprises:
creating at least one third indicator for describing at least one portion of a registration biometric of the user;
comparing said first and third indicators for yielding either a successful or failed second identification of the user; and
upon successful second identification of the user, authorizing access by the user to the at least one account.

67. The method of claim 66, wherein said at least one third indicator is readable from the token.

68. The method of claim 66, wherein said at least one third indicator is readable from memory at a location remote from the site where said creating at least one first indicator step is performed.

69. The method of claim 65, wherein said creating at least one first indicator further comprises digitizing at least a first portion of said analog biometric, said digitizing producing a first digital string describing said first portion, said at least one first indicator describing a second portion of said analog biometric, said first portion comprising said second portion, said second portion being smaller than said first portion.

70. The method of claim 65, wherein said creating at least one second indicator further comprises digitizing at least a first portion of said bid biometric, said digitizing producing a first digital string describing said first portion, said at least one second indicator describing a second portion of said bid biometric, said first portion comprising said second portion, said second portion being smaller than said first portion.

71. The method of claim 66, wherein said creating at least one third indicator further comprises digitizing at least a first portion of said registration biometric, said digitizing producing a first digital string describing said first portion, said at least one third indicator describing a second portion of said registration biometric, said first portion comprising said second portion, said second portion being smaller than said first portion.

72. The method of claim 65, further comprising storing said at least one first indicator in first memory.

73. The method of claim 72, further comprising:
upon said successful first identification of the user, clearing said at least one first indicator from said first memory.

74. The method of claim 65, further comprising storing said at least one bid biometric portion in first memory.

75. The method of claim 74, further comprising:
upon said successful first identification of the user, clearing said at least one bid biometric portion from said first memory.

76. The method of claim 74, further comprising:
upon said failed first identification of the user, storing said at least one bid biometric portion in a second memory.

77. The method of claim 66, further comprising storing said at least one first indicator in first memory.

78. The method of claim 77, further comprising:
upon said successful second identification of the user, clearing said at least one first indicator from said first memory.

79. The method of claim 66, further comprising storing said at least one bid biometric portion in first memory.

80. The method of claim 79, further comprising:
upon said successful second identification of the user, clearing said at least one bid biometric portion from said first memory.

81. The method of claim 79, further comprising:
upon said failed second identification of the user, storing said at least one bid biometric portion in a second memory.

82. A computer system for storing information comprising:
a processor; and
a memory coupled to the processor, the memory configured to store a plurality of code modules for execution by the processor, the plurality of code modules comprising:
a code module for creating at least one first indicator (digital string) describing a first portion of at least one biometric;
a code module for creating at least one second indicator (digital string) describing a second portion of said at least one biometric, said first portion comprising said second portion.

83. The system of claim 82, wherein said second portion is smaller than said first portion.

84. The system of claim 82, wherein said plurality of code modules further comprise:
a code module for comparing respective second indicators associated with two different ones of said at least one biometric;
a code module for yielding either a successful or failed first identification of a token user based on said comparing of said respective second indicators; and
a code module for authorizing access by the user to at least one account upon successful first identification of the user.
